(19) United States
(12) Patent Application Publication
(10) Pub. No.: US 2010/0312637 A1
(43) Pub. Date: Dec. 9, 2010

(54) Method of promoting the goods and services of an advertiser

(75) Inventors: James Irwin, Waco, TX (US); Brooke Irwin, Waco, TX (US)

Correspondence Address: NIXON & VANDERHYE, PC, 901 NORTH GLEBE ROAD, 11TH FLOOR, ARLINGTON, VA, 22203, US

(73) Assignee: Winstar International LLC, Waco, TX (US)

(21) Appl. No.: 12/801,285

(22) Filed: Jun. 1, 2010

Related U.S. Application Data
(60) Provisional application No. 61/213,382, filed on Jun. 3, 2009.

(51) Int. Cl. G06Q 30/00

(52) U.S. Cl. 705/14.39

(57) ABSTRACT

A method of advertising the goods and/or services of an advertiser on a website on a communications network that can be accessed by consumers with a communications device. Redeemable coupons are provided on the website for free goods and/or services of an advertiser on the website. Also, information is provided on the website on the retail locations of the advertisers closest to the consumer. Consumers can access the website, with a communications device; print or request desired redeemable coupons, visit a desired retail location of an advertiser and redeem a coupon or coupons to obtain the free goods and/or services without having to provide any personal information to the website or the advertiser.

### CROSS-REFERENCES TO RELATED APPLICATIONS

This application claims the priority of Provisional Patent Application No. 61/213,382, filed Jun. 3, 2009.

### BACKGROUND OF THE INVENTION

1. Field of the Invention

The present invention relates to a method of promoting the goods and services of an advertiser and, more particularly, to such a method wherein a website is used to offer online free products and/or services of an advertiser.

2. Description of the Background Art

Currently, no websites or other forms of advertising offer no-strings-attached free products and/or services to consumers. They all come with a catch, whether it is a data collection site that collects consumers' contact information or it is a site that offers free coupons (that give as little as cents off of retail costs). Advertisers currently “push” messages out to consumers in the hope that they not only hear it, but are influenced by it and ultimately purchase their products or services. Consumers are inundated with these “pushed” messages, and their daily routines are interrupted by forced commercials. A need has arisen, therefore, for a new concept of interne or online advertising that creates a “pull” by consumers who willingly and desirably visit the website. The new and improved method of the present invention meets this need.

### BRIEF SUMMARY OF THE INVENTION

In accordance with the method of the present invention, a website is created on a communications network such as the internet which can be accessed by a consumer with any suitable type of communications device, such as a computer, cell phone, handheld telecommunications device or the like. An advertiser may establish the website or may purchase space on the website of another party and offer free products or services periodically during a specified period. Advertisers determine which products or services they will give away and should have sufficient inventory to meet a minimum quota. The website offers coupons identifying the free products and/or services of each advertiser and the advertisers may place secondary ads on the printable coupons.

Consumers visit the website to view the free products or services offered by the advertisers. Upon selecting an advertiser, the user is directed to a page featuring the advertiser's current free product or service. The user can then print a coupon for the free product or service which will identify the advertiser's closest retail locations. Alternatively, the user can request that the coupon be sent to his or her mobile communications device such as a cell phone, handheld telecommunications device or the like. The consumer then visits the desired retail location and uses the printed coupon to obtain the free product or service. Other than the redemption of the coupon, the consumer does not have to provide any personal information to the website or the advertiser.

This is a new concept of internet or online advertising wherein consumers willingly and desirably visit a website to see what free offers are currently posted.

### BRIEF DESCRIPTION OF THE DRAWINGS

FIG. 1 is a schematic view of the communications network, website and communications devices that are used in accordance with the method of the present invention;

FIG. 2 is a block diagram illustrating generally the steps in the method of the present invention; and

FIG. 3 is an illustrative example of a screen shot that may be accessed on a website in accordance with the method of the present invention.

### DETAILED DESCRIPTION OF THE INVENTION

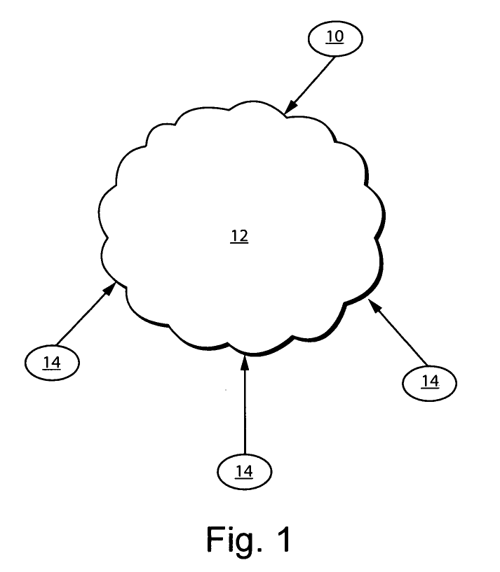

As shown in FIG. 1, a website 10 is provided on a communications network 12 on which advertisers offer free products or services each day for a specified advertising period. The website may be established by the advertiser or by another party that charges the advertiser a fee to offer free products or services on the website. Advertisers determine which products or services they will give away and must have sufficient inventory to meet a minimum quota of free products or services. The website provides coupons for the free goods or services of each advertiser and advertisers may place secondary ads on the coupons.

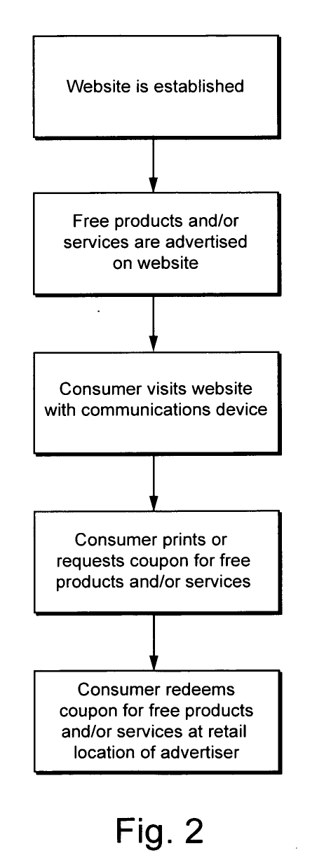

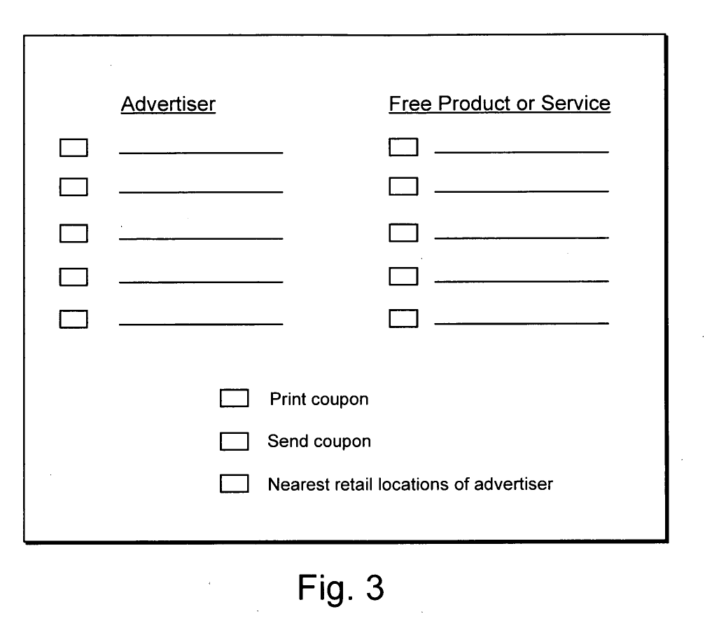

Consumers visit the website with the use of any suitable type of communications device 14, such as a computer, cell phone, handheld telecommunications device or the like, to view the free products or services currently offered by an advertiser. Upon selecting an advertiser, in the case of a website established by another party, the user is directed to a landing page or the like featuring the advertiser's free product or service. When the user finds a desired free product or service, the user confirms the selection and is directed to a coupon page which contains a bar code or the like for the free item or service as well as a list of the advertiser's closest retail locations. The consumer prints the coupon, visits the retail location and is given the free item by the advertiser. Alternatively, the consumer can request that the coupon be sent to his or her mobile communications device such as a cell phone, handheld telecommunications device or the like. These steps are shown in the block diagram of FIG. 2, and FIG. 3 shows an illustrative example of a screen shot 20 that might be produced on the website for viewing by a consumer who accesses the website.

In accordance with the method of the present invention, each consumer can redeem a specified number (e.g., one) of free items per day, and a specified number (e.g., one) of free items per advertiser each week. Consumers will have a specified period (e.g., up to seven days) to redeem the free item or service from the time the coupon is printed or sent. To obtain the free product or service, consumers merely redeem the coupon at the advertiser's retail location and do not have to provide any personal information, such as name, address or e-mail on the website or to the advertiser. Accordingly, consumers are not solicited in any way by the website or the advertisers. Consumers, therefore, willingly and desirably visit the website to see what free offers are posted each day. The consumer is taking the action, given the power and is not being forced to look at an advertisement. The consumer accesses the website by choice. This is a new and improved concept of internet or online advertising.

In this manner, advertisers are enticing consumers to traffic their stores. The advertisers are receiving traceable advertising with the website and can track the page views, clicks, coupons printed or sent, coupons redeemed by consumers, as well as additional purchases made by consumers who redeem coupons.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of advertising the goods and/or services of others on a website on a communications network that can be accessed by consumers with a communications device, comprising:
providing redeemable coupons on the website for free goods and/or services of advertisers who purchase space on the website;
whereby consumers can access the website with a communications device, print or request a desired redeemable coupon, visit a desired retail location of an advertiser and redeem the coupon to obtain the free goods and/or services without having to provide any personal information to the website or the advertiser.

2. The method of claim 1 further comprising providing information on the website on the retail locations of the advertisers closest to the consumer.

3. The method of claim 1 wherein the redeemable coupons contain additional advertising by the advertiser.

4. The method of claim 1 wherein the coupons expire within a specified period after being printed by the consumer.

5. The method of claim 1 wherein only a specified number of coupons may be printed by a consumer during a specified time period.

6. The method of claim 1 wherein the redeemable coupons contain a barcode for the redemption of the free product or service.

7. The method of claim 1 wherein the website is constructed to enable the consumer to use a communications device to access the website and view the free products and/or services of all advertisers each day.

8. The method of claim 1 wherein the coupons may be sent to the communications device of a consumer.

9. The method of claim 1 wherein the website provides to advertisers information on the page views and coupons printed or requested, and the advertisers can record the coupons redeemed and any purchases made by consumers who redeem coupons at the advertisers' retail locations.

10. A method of advertising goods and/or services of an advertiser on a website on a communications network that can be accessed by consumers with a communications device, comprising:
providing redeemable coupons on the website for free goods and/or services of the advertiser;
whereby consumers can access the website with a communications device, print or request a desired redeemable coupon, visit a desired retail location of the advertiser and redeem the coupon to obtain the free goods and/or services without having to provide any personal information to the website or the advertiser.

11. The method of claim 10 further comprising providing information on the website on the retail locations of the advertiser closest to the consumer.

12. The method of claim 10 wherein the redeemable coupons contain additional advertising by the advertiser.

13. The method of claim 10 wherein the coupons expire within a specified period after being printed by the consumer.

14. The method of claim 10 wherein only a specified number of coupons may be printed by a consumer during a specified time period.

15. The method of claim 10 wherein the redeemable coupons contain a barcode for the redemption of the free product or service.

16. The method of claim 10 wherein the website provides to advertisers information on the page views and coupons printed or requested, and the advertisers can record the coupons redeemed and any purchases made by consumers who redeem coupons at the advertisers' retail locations.

17. The method of claim 10 wherein the coupons may be sent to the communications device of a consumer.
